(19) United States
(12) Patent Application Publication
(10) Pub. No.: US 2004/0250706 A1
(43) Pub. Date: Dec. 16, 2004

(54) Method for activating the suction holes of rollers for paper converting machines and rollers for carrying out this method

(76) Inventor: Alessandro De Matteis, Picciorana (IT)

Correspondence Address: JASON A. BERNSTEIN, POWELL, GOLDSTEIN, FRAZER & MURPHY LLP, 16TH FLOOR, 191 PEACHTREE STREET, NE, ATLANTA, GA, 30303-1736, US

(21) Appl. No.: 10/696,978

(22) Filed: Oct. 30, 2003

(30) Foreign Application Priority Data
Oct. 31, 2002 (EP) EP 02425668.7

(51) Int. Cl. B30B 9/20

(52) U.S. Cl. 100/121

(57) ABSTRACT

For activating the suction holes on rollers of paper converting machines a plate is arranged in a sliding channel made longitudinally in a roller part of a roller by means of screws and comprises two rows of holes. The plate is equipped with interposition holes 2 which, if aligned as in FIG. 2, bring in communication suction holes of roller with a suction chamber made in roller and connected by means of a duct to an air suction system. Depending on the configuration, some suction holes are aligned to interposition holes, whereas other interposition holes, for example slotted holes, are in part overlapping suction holes and then in communication with suction chamber. By sliding plate 1 in the channel, the situation can change in order to bring all or different interposition holes aligned to suction holes.

### FIELD OF THE INVENTION

The present invention relates to paper converting machines and in particular it relates to a method for activating the suction holes located on rollers, such as winding rollers of rewinding machines, cutting rollers, rollers for interfolding machines, connected to the vacuum system of the machines. These holes cause a sheet or a web of paper to adhere to the roller same in certain operative phases. Furthermore, the invention relates to a device for carrying out this method.

### BACKGROUND OF THE INVENTION

As known, many machines used in the industry of the paper, for example rewinding and interfolding machines, are equipped with systems for keeping still a processed web or a sheet of paper on the surface of their rollers, in certain operative phases, in order to cause the paper to follow a predetermined path.

In particular, such systems provide the main operations of cutting the paper or of quickly transferring it from a roller to another and preventing it from jamming and then blocking the production.

To this purpose, the machines are equipped with, in many cases, air suction systems which, after producing a determined vacuum grade, allow the processed paper to adhere on the surface of the roller.

The vacuum is transmitted through a recess in the roller and allows the paper to adhere to the roller surface same by means of a plurality of holes. Normally, the holes are arranged in longitudinal rows with respect to the axis of the cylinder (transversal with respect to the paper) since the vacuum is supplied selectively, through distributor means suitably operated.

With this system, however, the modification is quite complicated of roller portion surface that is involved with the suction of the paper if, for production reasons, the width changes of the processed web or sheet.

Presently, in fact, for increasing or decreasing the suction activated surface portion it is necessary to stop the production and to carry out manually and singularly the covering of unnecessary holes with rudimental systems such as, for example, screw threaded stoppers or adhesive tape and start again the process.

Such operation has the drawbacks, firstly, of wasting time that affects, unavoidably, the costs of the process. Furthermore, in case an adhesive tape is used for covering the unused holes, it might accidentally detach. In this case suitable devices have to be used for testing the correct presence of the adhesive tape.

### SUMMARY OF THE INVENTION

It is a feature of the present invention to provide a method for activating the suction holes of rollers for paper converting machines that has not the above drawbacks.

It is another feature of the present invention to provide a method for activating the holes that is easy and quick to carry out by an operator.

It is a further feature of the present invention to provide a device that allows to carry out this method.

These and other features are achieved by the method according to the present invention, whose main feature is of slidingly move at least an interposition element between the suction holes of the rollers and a suction chamber, connected to a suction system suitable for creating a determined vacuum grade in the roller.

Advantageously, this interposition element is equipped with a plurality of interposition holes and is slidingly arranged in longitudinal direction or circumferentially with respect to the roller. Therefore, as the position of the interposition element varies a part of the interposition holes moves from a condition where they are aligned with the suction holes, bringing the latter in communication with the suction chamber, to a condition where they are not aligned with the suction holes, which are thus covered by the interposition element.

Preferably, at least one part of the interposition holes is slotted so that they are aligned with the suction holes in two or more positions of the interposition element.

According to a first exemplary embodiment of the invention the interposition element is a plate that houses in a sliding channel made longitudinally in the roller. Alternatively, the interposition element can be a tubular jacket, slidingly engaged between a tubular shell, where the suction holes are made, and a core where the suction chambers are made.

Advantageously, the tubular jacket is slidingly arranged in longitudinal direction.

Alternatively, said tubular jacket can rotate with respect to the roller. In this case, the surface of the tubular jacket has a plurality of couples of rows of holes arranged longitudinally and having different angular positions. In particular, each couple of rows has a different number of interposition holes so that it is possible to align a different number thereof with the corresponding suction holes according to the circumferential sliding movement.

In both cases, means are provided for changing quickly the relative position of the plate or of the jacket and the suction holes of the roller.

These means can comprise screws for adjusting the relative position between the interposition element and the suction holes of the roller.

### BRIEF DESCRIPTION OF THE DRAWINGS

Further characteristics and the advantages of the method for activating the suction holes of rollers for paper converting machines, according to the present invention, will be made clearer with the following description of an embodiment thereof with reference to attached drawings wherein:

FIG. 1 is a perspective view of a roller of a paper converting machines and of the vacuum distributor to it connected, as known in the art;

FIG. 2 shows a cross section of a roller that uses a first type of device for activating the holes according to the invention;

FIG. 3 shows a cross section of the device of FIG. 2 according to arrows III-III;

FIGS. 4A, 4B show in cross sectional view and FIG. 4C in a perspective view a device alternative to that of FIG. 2, for activating the holes of a roller;

FIG. 4 shows a device alternative to that of FIG. 2, for activating the holes of a roller;

Figs. from 5 to the 10 show three possible settings of the device according to the invention.

### DESCRIPTION OF THE INVENTION

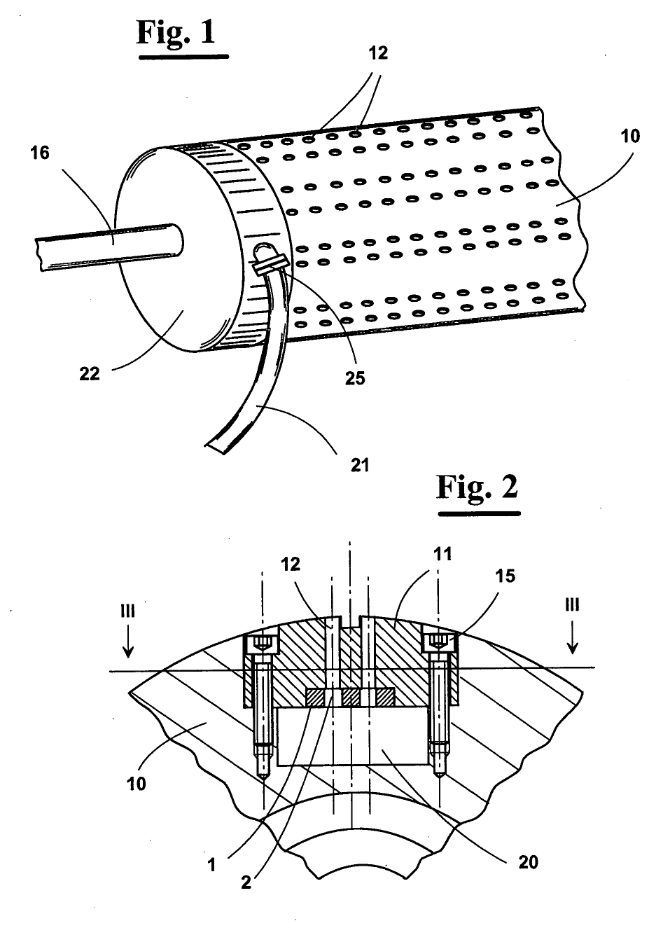

FIG. 1 shows, in a perspective exemplifying view, a roller 10 used, according to the prior art, in paper converting machines equipped with a plurality of suction holes 12 arranged in longitudinal rows and connected to a vacuum distribution system 22 in roller 10.

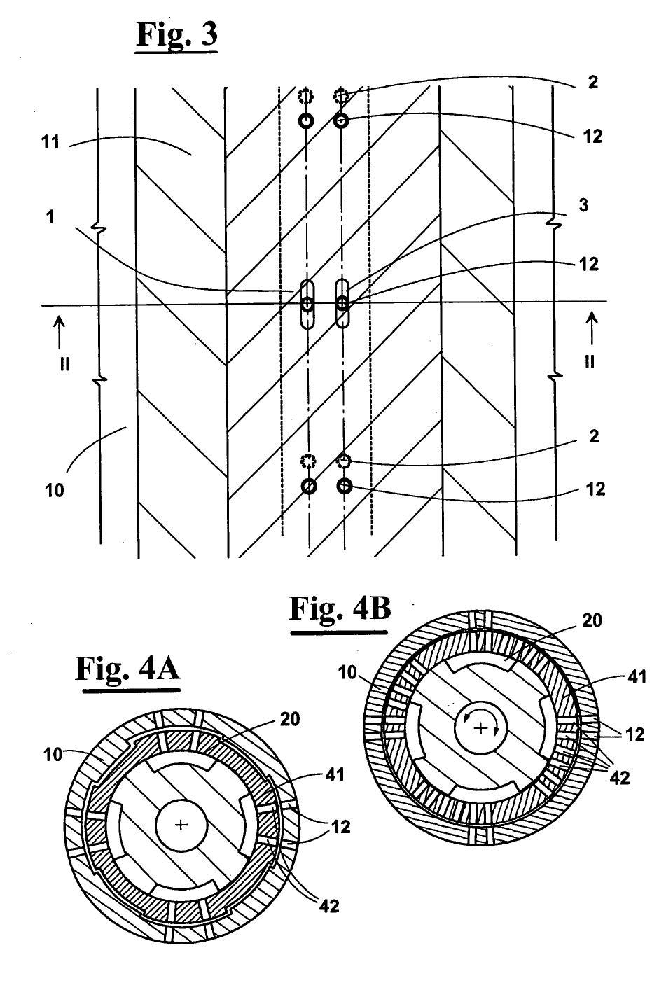

With reference to FIG. 2 a first embodiment of the device, according to the invention, for activating the suction holes on rollers 10 of paper converting machines 30 comprises a plate 1 arranged in a sliding channel made longitudinally in a roller part 11. The latter is connected to a roller 10 by means of screws 15 and comprises two rows of holes 12.

In particular, the plate 1 is provided with interposition holes 2 which, if aligned as in FIG. 2, bring in communication suction holes 12 of roller 10 with a suction chamber 20 made in roller 10 and connected by means of a duct 21 to the air suction system, here not shown and similar to that of FIG. 1.

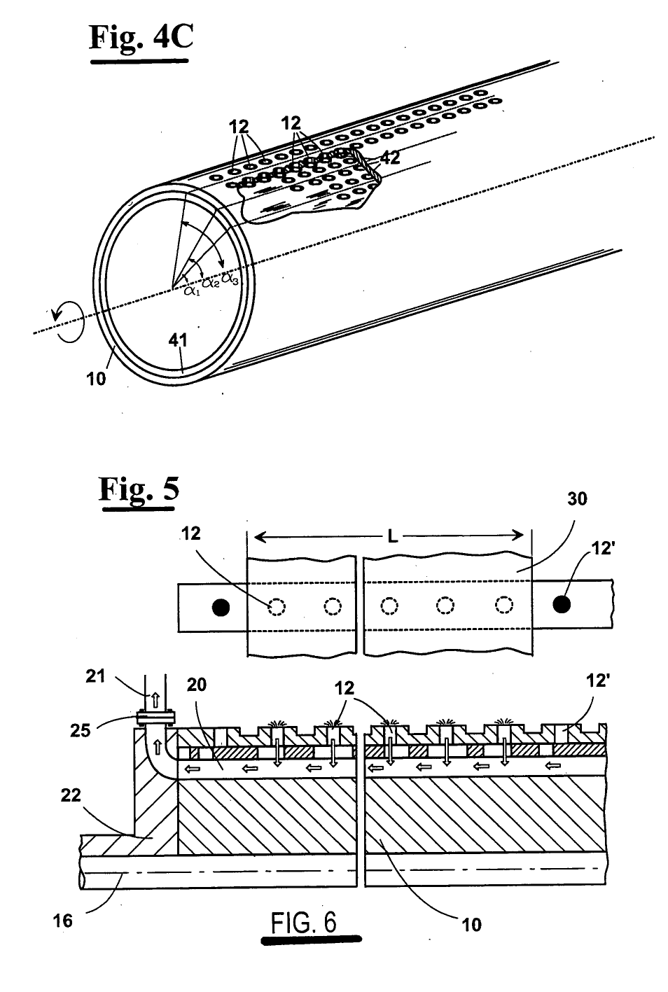

In FIG. 3 a possible arrangement is shown of plate 1, and then of interposition holes 2 with respect to suction holes 12.

In particular, is shown a determined configuration where some suction holes 12 are aligned to interposition holes 2, whereas other interposition holes 2, for example slotted holes 3, are in part overlapping suction holes 12 and then in communication with suction chamber 20. By sliding plate 1 in the channel, the situation can change in order to bring all or different interposition holes 2 aligned to suction holes 12.

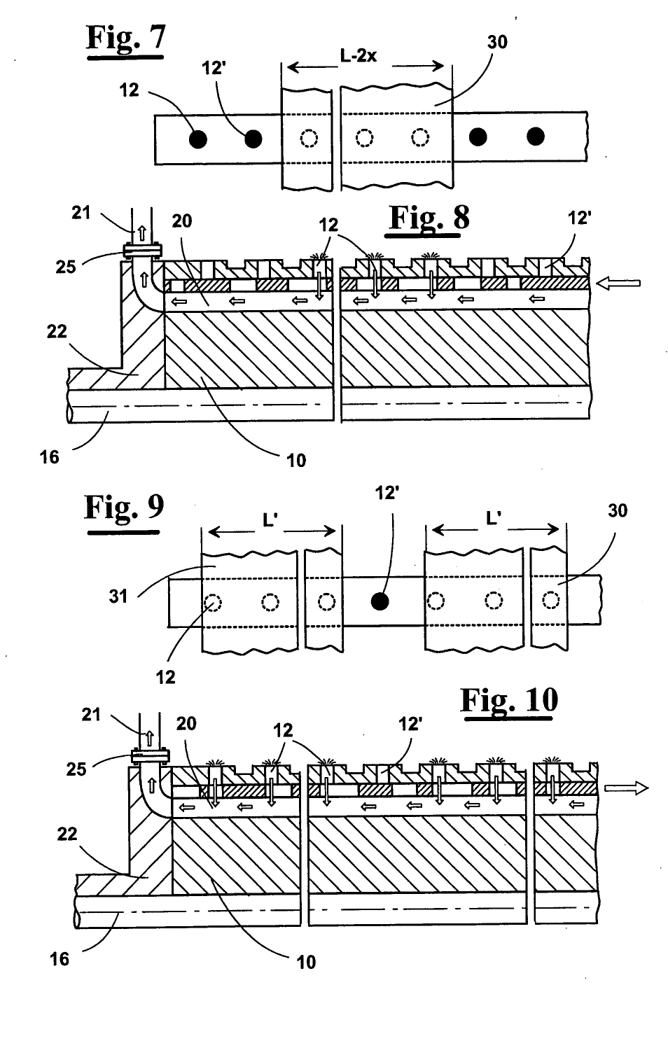

Such condition is achieved even with an alternative embodiment of the device shown in FIG. 4, according to a cross section orthogonal to the axis, and comprising a tubular jacket 41 provided with interposition holes 42 co-axial to roller 10. Jacket 41 has been over-dimensioned for graphical reason, but normally its width is a few mm.

According to the invention tubular jacket 41 can either simply slide longitudinally in roller 10 (FIG. 4A) or it can rotate with respect to it about its own axis (FIG. 4B). This way, it is possible to position interposition holes 42 with respect to suction holes 12 and then bringing the latter in communication with suction chamber 20, according to a predetermined configuration. As shown in detail in FIG. 4C, if the jacket 41 can rotate with respect to roller 10 (FIG. 4B), its surface has a plurality of longitudinal rows of interposition holes 42 each with a different number of holes. In particular, each of of interposition holes is arranged according to a different angular position. Therefore, the different configurations can be obtained causing jacket 41 rotate of corresponding angles α₁, α₂, α₃, etc., allowing suction rows 12 to align with the respective rows of interposition holes 42. This way only suction holes 12 are active, in that they correspond to holes 42.

In figures from 5 to 10 three possible configurations are shown of the device according to the invention. FIGS. 5 and 6 show diagrammatically, respectively in a top plan view and in longitudinal cross section, the device equipped with plate 1, according to the invention, during an operative step of the converting process of a web or sheet of paper 30. Suction holes 12′ (plain holes) that are located in roller portion 10 not run by the paper 30, of width L, are covered by plate 1, whereas suction holes 12 necessary to the suction of paper 30 are aligned to the interposition holes 12.

From the situation shown in FIGS. 5 and 6 it is possible, simply causing plate 1 to slide, to obtain the configuration that provides a sheet or web of paper 30 with lower width, for example with L−2x<L, (FIGS. 7 and 8).

In particular, with respect to the case of FIGS. 5 and 6 suction holes 12′ have been covered in roller portion 10 set between L−2x and L, i.e. those suction holes 12′ not more covered by the paper 30. On the other hand, suction holes 12 of roller portion 10 run by the paper 30, of width L−2x, are again aligned to the interposition holes 12 and are then active for the suction of paper 30.

Similarly, always with a simple sliding of plate 1 the situation is also possible, as shown in FIGS. 9 and 10, where a first sheet or web of paper 30 and a second sheet or web of paper 31, both of width <L are provided. Even in this case, suction holes 12′ (full holes), that are not necessary any more for suction of paper 30, since arranged in roller portion 10 set between the two sheets or webs of paper 30 and 31, are covered by plate 1.

Furthermore, sliding plate 1 is aligned to suction holes 12 (blank holes) and to interposition holes 2 located at roller portion 10 covered by paper 30 and 31.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

What is claimed:

1. The method for activating the suction holes on rollers of paper converting machines or similar products, said holes being in communication with a suction chamber made in the rollers and connected by suction means, characterised in that it provides the sliding of at least an interposition element between said holes and said suction chamber, said interposition element being equipped with a plurality of interposition holes whereby, as the position of said element varies, at least one part of said interposition holes moves from a condition where they are aligned with said suction holes, bringing them in communication with said chamber, to a condition where they are not aligned with said suction holes, which are thus covered by said interposition element.

2. The method according to claim 1, wherein at least one part of said interposition holes is slotted so that they are aligned with said suction holes in two or more positions of said interposition element.

3. The method according to claim 1, wherein said sliding is carried out in longitudinal direction.

4. The method according to claim 1, wherein said sliding is carried out in a circumferential direction.

5. The device for activating the suction holes on rollers of paper converting machines, said holes being in communication with a suction chamber made in the rollers and connected by suction means, characterised in that it provides at least an interposition element sliding between said suction holes and said suction chamber equipped with a plurality of interposition holes.

6. The device according to claim 5, wherein said interposition element is a plate that is housed in a sliding channel made longitudinally in said roller.

7. The device according to claim 5, wherein said interposition element is a tubular jacket, slidingly engaged between a tubular shell where said suction holes are made, and a core where said suction chambers are made.

8. The device according to claim 5, wherein at least one part of said interposition holes is slotted so that they are aligned with said suction holes in two or more positions of said interposition element.

9. The device according to claim 7, wherein the surface of said tubular jacket has a plurality of couples of rows of holes arranged longitudinally and having different angular positions, each couple of rows having a different number of interposition holes in order to align a different number thereof to the corresponding suction holes by a circumferential sliding movement.

10. The device according to the previous claims, wherein means are provided for changing quickly the relative position of said interposition element and the suction holes of said roller.

11. The device according to claim 10, wherein said means for changing comprise screws for adjusting the relative position between said interposition element and the suction holes of said roller.
